(19) United States
(12) Patent Application Publication
(10) Pub. No.: US 2025/0365551 A1
(43) Pub. Date: Nov. 27, 2025

(54) SYSTEMS AND METHODS FOR USING SOUND EFFECTS TO INDICATE LOCATION INFORMATION FOR DETECTED OBJECTS

(71) Applicant: Microchip Technology Inc., Chandler, AZ (US)

(72) Inventor: Keith Curtis, Queen Creek, AZ (US)

(73) Assignee: Microchip Technology Inc., Chandler, AZ (US)

(21) Appl. No.: 19/194,448

(22) Filed: Apr. 30, 2025

Related U.S. Application Data
(60) Provisional application No. 63/651,452, filed on May 24, 2024.

(51) Int. Cl. H04S 7/00; G09B 21/00; H04R 5/033

(52) U.S. Cl. CPC H04S 7/304; G09B 21/001; H04R 5/033; H04S 2400/11

(57) ABSTRACT

A system includes a view direction sensor configured to determine a viewing direction of the user, an object mapping system to determine a location of an object feature of an object relative to a user, a wearable stereo speaker system including a first speaker and a second speaker, and control circuitry to analyze the determined location of the object feature relative to the determined viewing direction of the user and output non-verbal sounds via the first and second speakers of the wearable stereo speaker system to indicate the determined location of the object feature relative to the determined viewing direction of the user.

### RELATED APPLICATION

This application claims priority to commonly owned U.S. Provisional Patent Application No. 63/651,452 filed May 24, 2024, the entire contents of which are hereby incorporated by reference for all purposes.

### TECHNICAL FIELD

The present disclosure relates to systems and methods for using sound effects to indicate location information for detected objects, e.g., for assisting a visually challenged person.

### BACKGROUND

There are various systems for helping visually challenged (e.g., blind or sight-impaired) individuals detect nearby objects. A significant challenge concerns how to represent information regarding detected objects in an intuitive manner allowing a visually challenged individual to determine the direction and distance of respective objects.

Some existing systems use voice direction to describe detected objects. For example, a remote viewer may relay the path ahead of a visually challenged individual and verbally relate the information to the individual. Such systems are typically slow and nonintuitive.

Other systems use tactile feedback, e.g., vibrations on the skin, to provide an individual information regarding the direction and distance of objects. For example, one system utilizes solenoid pins that “draw” a detected image on the user's skin. However, such system often have low resolution and may be nonintuitive.

There is a need for improved systems and methods for provide a spatial representation of objects in a person's surroundings, e.g., indicating the direction and distance of nearby objects, for example surfaces and edges of respective objects.

### SUMMARY

Human brains utilize “spatial hearing” to determine locations (e.g., direction, distance, and elevation) of sound sources. For example, the brain can determine the direction of a sound source using signals from both ears spaced apart by a lateral distance. In addition, the brain can determine the elevation of a sound source using reflection-related delays created by the complex shape of the outer ear. Using both the lateral separation of the ears (for determining lateral direction) and the shape of the outer ear (for determining elevation), the brain can acoustically determine a three-dimension vector to a sound source.

Examples of the present disclosure provide systems and methods that generate and output audible tones to a user (e.g., a visually challenged person) to indicate to the user the direction and distance of nearby objects. Some aspects of disclosed systems and methods are based on the concepts of spatial hearing, i.e., a user's ability to determine the direction of a sound source relative to the user. The disclosed systems and methods may allow a user (e.g., a visually challenged person) to acoustically identify the location of objects in their path or environment. Such systems and methods may be intuitive and easy to learn to use, as they may utilize the user's innate ability for spatial hearing. This may allow the user to “see” objects in their mind's eye without having to translate from another spatial format or guess at the location based on text, e.g., as with certain conventional systems.

Some examples provide a system that outputs tones from a stereo headset worn by a user to represent detected objects, wherein the tones are output from the left and right headset channels with differential audio signals that are perceived by the user as coming from the actual directions of the respective objects relative to the user.

The system may use different sound effects to indicate (to the user) different types of object features, for example, a continuous tone to represent an edge (or center point of an edge), a tone with a vibrato effect to represent a horizontal plane (or center point of a horizontal plane), and a tone with a tremolo effect to represent a vertical plane (or center point of a vertical plane).

In addition, the system may adjust various audio effects of sound effects output to the user to indicate additional information regarding respective object features. For example, for a respective object feature (e.g., edge) having an associated sound effect (e.g., continuous tone, tone with vibrator, or tone with tremolo), the system may provide location information regarding a respective object feature by (a) generating a stereo effect by applying differential effects (e.g., differential amplitudes and/or a time delay) to the sound effect output by right ear and left ear speakers to indicate a lateral (left-right) direction of the object feature and/or (b) adjusting an audio effect (e.g., amplitude, pitch, etc.) of the sound effect as a function of an angular offset between the viewing direction VD and a vector extending from the user to the object feature.

In addition, the system may dynamically adjust one or more audio effects (e.g., amplitude, tone, vibrato speed, or tremolo speed) of the respective sound effect (e.g., continuous tone, tone with vibrator, or tone with tremolo) for the respective object feature to indicate (a) the distance between the user and the object feature, and/or (b) a size of the object feature.

In some examples, the system may simultaneously output multiple sound effects corresponding with multiple object features, wherein the user's brain may separate different sound effects associated with different object features. Different combinations of simultaneously output sound effects may define different “chords” that the user may mentally associate with different types of objects, for example vehicles, buildings, other people, sidewalks, signs, etc.

In some examples, the system may provide a higher resolution spatial representation for selected object locations relative to the user. For example, the system may (a) perform normal operation when the user's viewing direction is horizontal (e.g., within 15 degrees from horizontal), wherein the system generates sounds for object features located within a 90 degree field of view, and (b) perform a focused operation when the user's vision is outside of horizontal (at least 15 degrees above or below horizontal), wherein the system generates sounds for object features located within a 30 degree field of view. The user's viewing direction may be determined by a gyroscope, accelerometer, and/or other sensor(s) in a headset worn by the user, for example.

Disclosed system and method may provide various advantages. For example, the disclosed systems and methods may provide a more intuitive interface for users, as compared with conventional techniques; for instance, disclosed systems may require no mental translation of input, and may utilize the user's mind's eye view. As another example, disclosed systems and methods may transmit both edges and planes of objects. As another example, disclosed systems and methods may provide a higher resolution for nearer edges and planes. As another example, disclosed systems and methods may provide an intuitive input to the system for a focus of view.

One aspect provides a system including a view direction sensor configured to determine a viewing direction of the user, an object mapping system to determine a location of an object feature of an object relative to a user, a wearable stereo speaker system including a first speaker and a second speaker, and control circuitry to analyze the determined location of the object feature relative to the determined viewing direction of the user and output non-verbal sounds via the first and second speakers of the wearable stereo speaker system to indicate the determined location of the object feature relative to the determined viewing direction of the user.

In some examples, the object mapping system comprises a Lidar sensor system, an optical scanning system, a sonar-based sensor system, or a database storing object location data for respective object features of respective objects in an environment.

In some examples, the wearable stereo speaker system comprises headphones, a headset, earbuds, or earphones.

In some examples, the object feature comprises an edge of the object, a center point of an edge of the object, a plane of the object, or a center point of a plane of the object.

In some examples, the control circuitry includes circuitry to determine a class of the object feature from multiple different classes of object features, select from multiple different types of sound effects a sound effect corresponding with the determined class of the object feature, and output the selected sound effect via the wearable stereo speaker system to indicate the class of the object feature.

In some examples, the different classes of object features include an object edge feature and an object plane.

In some examples, the different types of sound effects include at least one of a vibrato or a tremolo.

In some examples, the control circuitry includes circuitry to dynamically adjust an audio effect of respective non-verbal sounds output by the wearable stereo speaker system as a function of a distance of the detected object feature relative to the user, wherein the audio effect includes at least one of an amplitude, a pitch, a vibrato speed, or a tremolo speed.

In some examples, the control circuitry includes circuitry to dynamically adjust an audio effect of respective non-verbal sounds output by the wearable stereo speaker system as a function of a size of the detected object feature, wherein the audio effect includes at least one of an amplitude, a pitch, a vibrato speed, or a tremolo speed.

In some examples, the object mapping system is configured to determine a respective location of each of multiple object features in a field of view of the user, and the control circuitry is configured to output respective non-verbal sounds for each of the multiple object features via the wearable stereo speaker system, wherein the respective non-verbal sounds indicate the respective location of each of the multiple object features relative to the user.

In some examples, the control circuitry is configured to output the respective non-verbal sounds for the multiple object features simultaneously via the wearable stereo speaker system.

In some examples, the control circuitry is configured to output the respective non-verbal sounds for the multiple object features in an alternating manner.

In some examples, the view direction sensor is securable to the user head and configured to determine the viewing direction of the user by determining an angular orientation of the user's head.

In some examples, the control circuitry includes circuitry to output differential audio signals from the first speaker and second speaker to create a stereo effect indicating to the user a lateral direction of the object feature relative to the viewing direction of the user.

In some examples, the control circuitry includes circuitry to dynamically adjust an audio effect of respective non-verbal sounds output by the wearable stereo speaker system as a function of the determined location of the object feature relative to the determined viewing direction of the user.

In some examples, the control circuitry includes circuitry to adjust an angular field of view as a function of the detected viewing direction of the user, wherein the angular field of view at least partially defines an viewed space in which a detection of the object feature causes the output of respective non-verbal sounds via the wearable stereo speaker system.

In some examples, the view direction sensor is configured to determine a vertical viewing angle of the user, and the control circuitry includes circuitry to adjust an angular field of view in at least one direction, wherein the angular field of view at least partially defines a viewed space in which a detection of the object feature causes the output of respective non-verbal sounds via the wearable stereo speaker system.

Another aspect provides a device including a processor, and non-transitory memory storing logic instructions executable by the processor to receive information from an object mapping system indicating a location of an object feature of an object relative to a user, receive information from a wearable view direction sensor indicating a viewing direction of the user, analyze the determined location of the object feature relative to the determined viewing direction of the user, and output non-verbal sounds via a wearable stereo speaker system to indicate the determined location of the object feature relative to the determined viewing direction of the user.

In some examples, the logic instructions are executable by the processor to dynamically adjust an audio effect of respective non-verbal sounds output by the wearable stereo speaker system as a function of a distance or a size of the detected object feature relative to the user, wherein the audio effect includes at least one of an amplitude, a pitch, a vibrato speed, or a tremolo speed.

Another aspect provides a method including receiving, by a control circuit, information from an object mapping system indicating a location of an object feature of an object relative to a user; receiving, by the control circuit, information from a wearable view direction sensor indicating a viewing direction of the user; analyzing, by the control circuit, the determined location of the object feature relative to the determined viewing direction of the user; and outputting, by the control circuit, non-verbal sounds via a wearable stereo speaker system to indicate the determined location of the object feature relative to the determined viewing direction of the user.

### BRIEF DESCRIPTION OF THE DRAWINGS

Example aspects of the present disclosure are described below in conjunction with the figures, in which:

FIG. 1 shows an example system for outputting audio sounds to a user, e.g., a hearing impaired user, to indicate the respective locations of detected object features;

FIGS. 2A and 2B show an example scenario of a user wearing the example system of FIG. 1 and walking along a sidewalk, wherein the system generates and outputs sounds indicating the respective locations of object features in a viewing space of the user;

FIGS. 3A and 3B show an example scenario of a user wearing the example system of FIG. 1 and walking along a sidewalk and approaching a curb, wherein the system generates and outputs sounds indicating the respective locations of object features in a viewing space of the user;

FIG. 4 shows an example scenario of a user wearing the example system of FIG. 1 and walking along a sidewalk with a building to the left and a curb to the right, wherein the system generates and outputs sounds indicating the respective locations of object features in a viewing space of the user; and

FIG. 5 shows an example scenario of a user wearing the example system of FIG. 1 and walking toward a building with a double door, wherein the system generates and outputs sounds indicating the respective locations of object features in a viewing space of the user.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

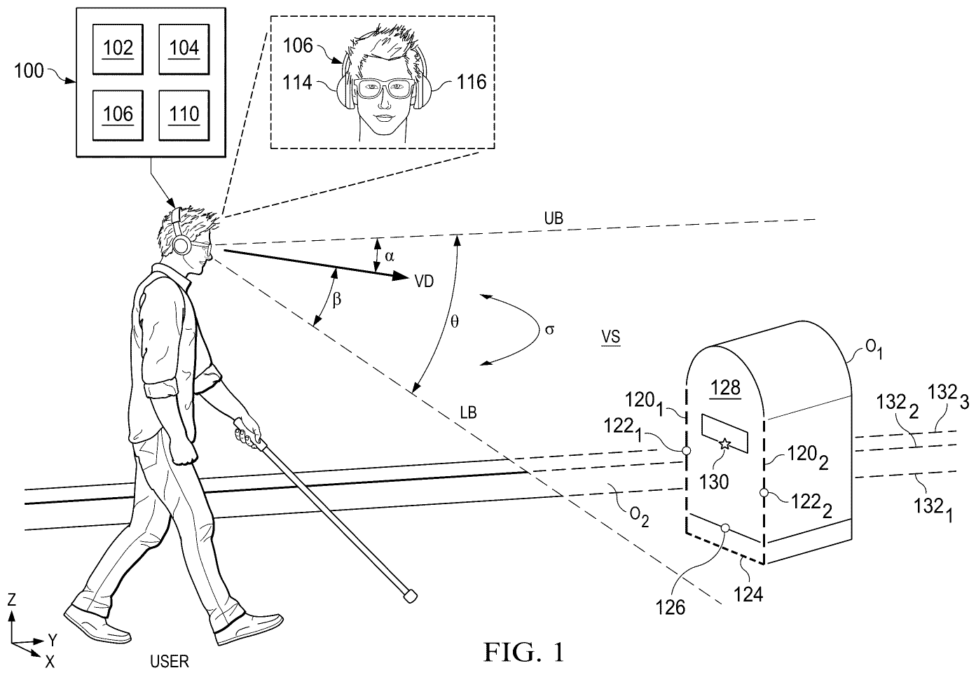

FIG. 1 shows an example system 100 for outputting audio sounds to a user, e.g., a hearing impaired user, to indicate the respective locations of detected object features. The example system 100 includes an object mapping system 104, a wearable stereo speaker system 106, a view direction sensor 102, and control circuitry 110.

Control circuitry 110 may include circuitry for performing various functionality of system 100 disclosed herein, for example analyzing data from the view direction sensor 102 and object mapping system 104 and generating sound signals for output via the wearable stereo speaker system 106 to indicate the respective locations of detected object features. For example, control circuitry 110 may include at least one processor (e.g., a microcontroller, microprocessor, or other processor) and logic instructions embodied as software and/or firmware stored in memory (e.g., RAM, ROM, Flash, or other type(s) of memory) and executable by the processor to perform various functionality disclosed herein.

One or more components of system 100 may be embodied in a wearable device or devices, for example, a headset (e.g., including headphone speakers), headband, hat, or glasses. In addition, in some examples, one or more components of system 100, for example, control circuitry 102 or components of control circuitry 102, may be provided in a smartphone or other device carried by the user, or may be provided in a remote computer system or systems (e.g., a remote server) connected to components of system 100 provided at the user (e.g., embodied in a wearable device) by any suitable wireless communication link(s).

The view direction sensor 102 may comprise a sensor or sensor system to determine a viewing direction VD of the user, which viewing direction may be used by control circuitry 110 for various functionality as discussed below. In some examples, the view direction sensor 102 may comprise at least one of a gyroscope, accelerometer, magnetometer, or other orientation sensor provided in or affixed to the wearable stereo speaker system 106 to monitor an orientation (e.g., vertical and/or lateral angular orientation) of the user's head. In some examples, the view direction sensor 102 and object mapping system 104 may comprise an integrated system, e.g., embodied in specialized glasses or a headset (integrated with or separate from the wearable stereo speaker system 106), to determine the user's viewing direction VD and to map respective object features relative to the viewing direction VD. In other examples, the view direction sensor 102 and object mapping system 104 may comprise separate modules, e.g., embodied in physically distinct components of system 100.

As discussed below, in some examples, control circuitry 110 may determine a viewed space VS associated with the viewing direction VD, identify the respective object features located within the viewed space, as determined by object mapping system 104, and output non-verbal sounds via the wearable stereo speaker system 104 to indicate the locations of respective object features relative to the user.

In some examples, e.g., for use with sight-impaired users, the viewing direction VD determined by the view direction sensor 102 may be defined by the physical orientation of the user's head relative to one, two, or three axes of rotation (e.g., the x-axis, y-axis, and/or z-axis shown in FIG. 1), regardless of the direction of sight or orientation (or open/closed state) of the user's eyes. In other examples, e.g., for use with sighted users, the view direction sensor 102 may be configured to monitor a direction of sight or orientation of the user's eyes, which may define the user's viewing direction VD.

The viewed space VS corresponding with the viewing direction VD may be defined based on viewed space rules stored in memory accessible to control circuitry 110. Viewed space rules may define a viewed space VS based on an angular field of view relative to the viewing direction VD and/or distance limits relative to the user. As one example, viewed space rules may specify the viewed space VS is (a) defined by an angular field of view defined by field of view angles in one or more directions, for example (i) a vertical (z-direction) field of view angle θ defined between an upper boundary UB and lower boundary LB defined by offset angles of α degrees and β degrees above and below the determined viewing direction VD, respectively, wherein the offset angles α and β may be the same or different predefined values and (ii) a horizontal (x-direction) field of view angle σ between a left-side boundary and a right-side boundary defined by predefined offset angle(s) to the left and right of the determined viewing direction VD, and (b) limited by a defined view distance limit away from the user, such that object features within the defined view distance limit are processed.

In some examples, viewed space rules may include rules that dynamically vary one or more aspects defining the viewed space VS, for example an angular field of view and/or view distance limit, as a function of defined conditions, for example as a function of the viewing direction VD, the operational situation (e.g., indoor, outdoor, night time, day time, etc.). For example, the control circuitry 102 may automatically adjust the vertical field of view angle θ and/or the horizontal field of view angle σ as a function of the vertical angle of the viewing direction VD (relative to the ground or horizontal). In one example, the control circuitry 102 automatically decreases the vertical field of view angle θ and horizontal field of view angle σ by defined percentages or degrees when the viewing direction VD drops below a defined angle (e.g., 60 degrees) above horizontal, which may reduce the number of object features in the viewed space and thereby allow the user to better focus on the respective sounds indicating the location of the individual (or small number of) object features.

The object mapping system 104 may be configured to map (i.e., determine or calculate the location of) respective object features of various objects relative to the user, for example including object features within a viewed space VS. As used herein, an “object feature” refers to a physical object (e.g., a building, vehicle, sign, sidewalk, curb, tree, or any other type of object) or a geometric feature or other feature of a physical object, for example an edge or surface (e.g., planar or non-planar surface) of a respective object, or an endpoint or center point of an edge or surface of a respective object, without limitation. Different types of object features may be referred to herein as “classes” of object features. Example classes of object features may include, for example, a vertical edge, a horizontal edge, a vertical plane, a horizontal plane, a curved surface, etc.

FIG. 1 shows two example objects in the viewed space VS of the user (discussed below), namely a mailbox (O₁) and a curb (O₂) having respective object features detected and mapped by the object mapping system 104. For the mailbox object, the object mapping system 104 may map (a) vertical edges 1201 and 1202, each having a respective center point 1221 and 1222, (b) horizontal edge 124 having a center point 126, and (c) a front surface (plane) 128 having a center point 130. For the curb object, the object mapping system 104 may map horizontal edges 1321, 1322, and 1323., each having a respective center point (not shown), for example defined by a center point of the partial length of the curb within the viewed space VS.

In some examples, the object mapping system 104 comprises a Lidar sensor system, an optical scanning system, or a sonar-based sensor system. In other examples, the object mapping system 104 may comprise an object feature database storing location data for respective object features of respective objects in an environment, and circuitry (e.g., including a processor) for accessing location data from the object feature database.

The wearable stereo speaker system 106 may be configured to output non-verbal sounds to indicate the determined locations of respective object features relative to the user. The wearable stereo speaker system 106 may comprise at least a first speaker 114 (e.g., right ear speaker) and a second speaker 116 (e.g., left ear speaker), which speakers may be embodied as stereo headphones, a stereo headset, stereo earbuds, or stereo earphones, for example.

In some examples, control circuitry 110 may be configured to construct a 3D model (e.g., a wire-frame model) of the environment near the user, including at least the viewed space VS, based on data from the view direction sensor 102 and object mapping system 104. The 3D model may include (at least) various object features located in the viewed space VS, including the example object features 120-132 shown in FIG. 1 and discussed above.

Control circuitry 110 may then determine and generate, adjust, or otherwise control non-verbal sounds to be output to the user via the wearable stereo speaker system 106 to indicate the locations of respective object features included in the 3D model.

Control circuitry 110 may then determine and generate, adjust, or otherwise control non-verbal sounds output to the user via the wearable stereo speaker system 106 to indicate the classes (types) and locations of respective object features included in the 3D model. For example, control circuitry 110 may generate different types of sound effects (e.g., a continuous tone, a tone with vibrato, a tone with tremolo, etc.) to indicate different types of object features, for example vertical edges, horizontal edges, vertical planes, and horizontal planes, without limitation. In one example, control circuitry 110 may generate continuous tones for vertical and horizontal edges (e.g., using different frequencies or otherwise distinguishing vertical from horizontal edges), a tone with tremolo effect for vertical planes, and a tone with vibrato effect for horizontal planes. For examples, control circuitry 110 may generate a respective continuous tone indicating the center point location of each respective edge (vertical and horizontal), a tone with tremolo indicating the center point location of a respective vertical plane, and a tone with vibrato indicating the center point location of a respective horizontal plane.

Control circuitry 110 may indicate the relative location of a respective object feature (e.g., vertical edge, horizontal edge, vertical plane, or horizontal plane) relative to the user in various manners, depending on the particular implementation or system settings. For example, control circuitry 110 may user stereo effects to indicate a lateral direction of a respective object feature relative to the user's viewing direction VD, by generating and outputting differential audio signals (e.g., differential amplitudes and/or a time delay) from the right ear speaker 114 and left ear speaker 116 to create a stereo effect indicating a lateral (e.g., left-right) direction of the object feature. Alternatively, or in addition to generating such stereo effects, control circuitry 110 may adjust one or more audio effects, for example amplitude, pitch, vibrato speed, and/or tremolo speed, as a function of a determined angular offset between (i) a vector from the user (e.g., the object mapping system 104) to the object feature, referred to herein as the object feature vector, and (ii) the user's viewing direction VD. The user may move their head and evaluate the change in the audio effect to gain information on the locations of respective object feature. For example, if the audio effect increases in response to the user moving their head, the user can deduce their viewing direction VD is approaching the object feature vector.

In addition to providing the user information regarding the locations of respective object feature as discussed above, system 100 may provide the user information regarding the distance of the object feature from the user and/or the size of the object feature. For example, for a respective object feature, control circuitry 110 may adjust one or more audio effects (for example amplitude, pitch, vibrato speed, and/or tremolo speed) as a function of (a) a distance between the user and the respective object feature, and/or (b) a size of the respective object feature.

For example, in one example implementation, for a respective object feature having an associated tone, the control circuitry 110 may (a) generate a stereo effect by applying differential effects (e.g., differential amplitudes and/or a time delay) at the right and left speakers 114 and 116 to indicate a lateral direction of the object feature, (b) provide additional location information by adjusting the amplitude of the tone as a function of an angular offset between the object feature vector and viewing direction VD, (c) adjust the pitch of the tone as a function of the distance between the user and the object feature, and/or (c) adjust a vibrato speed or tremolo speed as a function of size of the object feature (in the case the tone includes a vibrato or tremolo effect).

In some examples, multiple sound effects corresponding with multiple object features are output simultaneously via the wearable stereo speaker system 106, wherein the user's brain may separate different sound effects associated with different object features. Multiple sound effects simultaneously output to the user may create a “chord.” Certain types of objects, for example cars, buildings, or mailboxes, may each have a respective shape including a respective collection of edges and planes that produce a respective chord that may be identified by the user after a training period. For example, referring to FIG. 1, control circuitry 110 may generate (a) a pair of first-frequency tones corresponding with vertical edges 1201 and 1202, (b) a second-frequency tone corresponding with horizontal edge 124, and (c) a third-frequency tone having a vibrato effect corresponding with the vertical plane 128. These sound effects may be simultaneously output to the user may create a chord that the user may mentally correlate with a large mailbox (e.g., after a training process or practice using the system 100).

In other examples, respective sound effects corresponding with multiple object features may be output to the user in an alternating (non-simultaneously) manner via the wearable stereo speaker system 106. Similar to the chords discussed above, the user may correlate a particular sequence of sound effects with a particular type of object (car, building, or mailbox).

In some examples, control circuitry 110 may generate and output verbal sound effects in addition the non-verbal sound effects discussed above, e.g., to provide the user a more comprehensive experience.

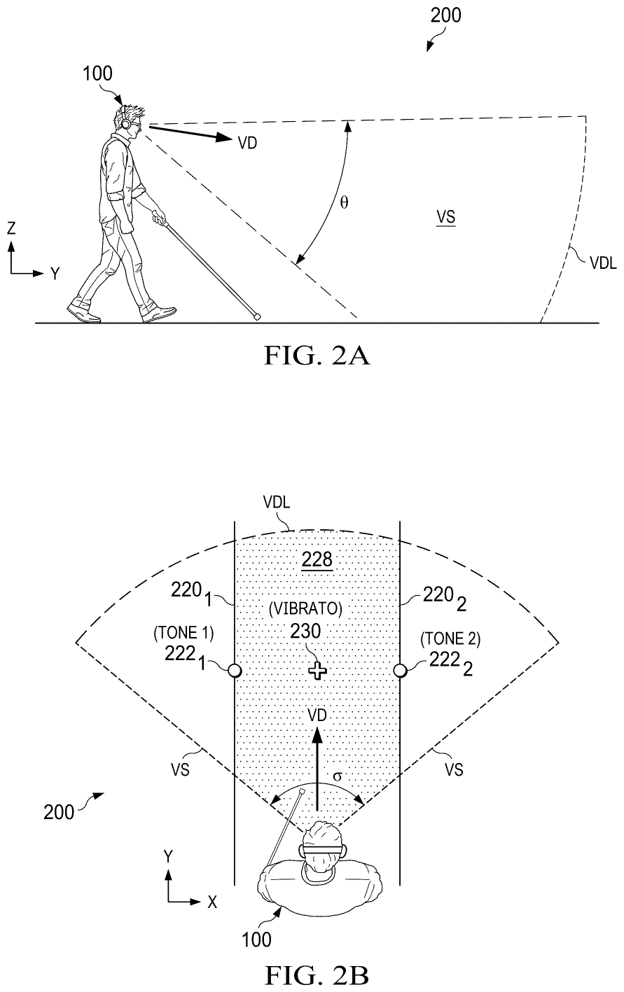

FIGS. 2A-2B through FIG. 5 show example functioning of the example system 100 in various example scenarios.

First, FIG. 2A shows a side view and FIG. 2B shows a top-down view of an example scenario 200 of a user wearing system 100 walking along a sidewalk, wherein system 100 includes the various elements shown in FIG. 1. As shown, control circuitry 110 of system 100 may determine a viewed space VS associated with a viewing direction VD determined by the view direction sensor 102, wherein the viewed space VS is defined at least by a vertical field of view angle θ, a horizontal field of view angle σ, and a view distance limit VDL.

Referring to FIG. 2B, the object mapping system 104 may identify edges 2201 and 2202 of the sidewalk, and control circuitry 110 may determine center points 2221 and 2222 of the lengths of edges 2221 and 2222 within the viewed space VS, and a center point 230 of the sidewalk area 228 (i.e., horizontal plane) within the viewed space VS. The control circuitry 110 may generate and output, via wearable stereo speaker system 106 of system 100, (a) a first tone indicating the location of the sidewalk edge center point 2221, (b) a second tone indicating the location of the sidewalk edge center point 2222, and (c) a tone with vibrato indicating the location of the center point 230 of the sidewalk area 228 within the viewed space VS. As discussed above, the tones for center points 2221, 2222, and 230 may be output with a stereo effect via the left and right speakers 114 and 116 to audibly indicate to the user the lateral direction of the respective center points 2221, 2222, and 230 relative to the viewing direction VD.

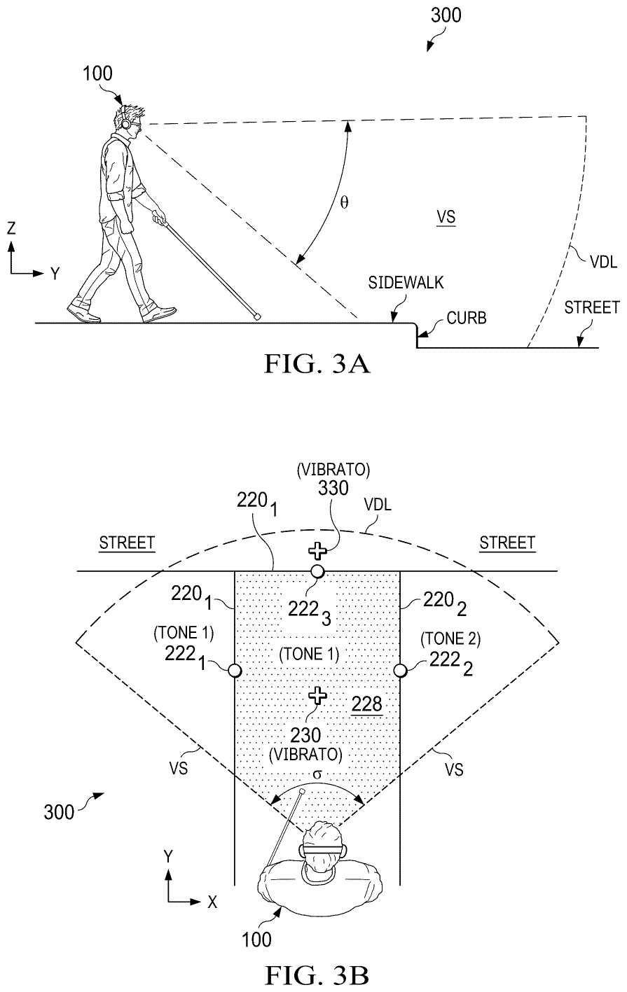

As the user walks along the sidewalk, the viewed space VS moves forward along with the user, and the locations of the center points 2221, 2222, and 230 also move forward (each remaining a fixed distance in front of the user), at least until the user approaches the end of the sidewalk, as discussed below with reference to FIGS. 3A-3B.

Next, FIG. 3A (side view) and FIG. 3B (top view) show an example scenario 300 similar to the scenario 200 shown in FIG. 2A-2B, but wherein the user is approaching the end of the sidewalk, in particular defined by a curb separating the sidewalk from a street. In this example, the object mapping system 104 may further identify the curb (edge) 2203, and control circuitry 110 may determine a center points 2223 of the lengths of curb 2223 within the viewed space VS, and also a center point 330 of the area of the street (i.e., horizontal plane) within the viewed space VS.

The control circuitry 110 may generate an output, via wearable stereo speaker system 106 of system 100, respective sound effects for the edge center point 2221 (tone 1), edge center point 2222 (tone 2), curb center point 2223 (tone 3), sidewalk area center point 230 (vibrato 1), and street area center point 330 (vibrato 2).

Unlike in the example of FIGS. 2A-2B in which the tones for center points 2221, 2222, and 230 remaining a fixed distance in front of the user as the user advances, in the example of FIGS. 3A-3B the sidewalk and edge center points 2221, 2222, 2223, and the sidewalk area center point 230 will move closer to the user as the user advances, which may indicate to the user the end of the sidewalk is approaching.

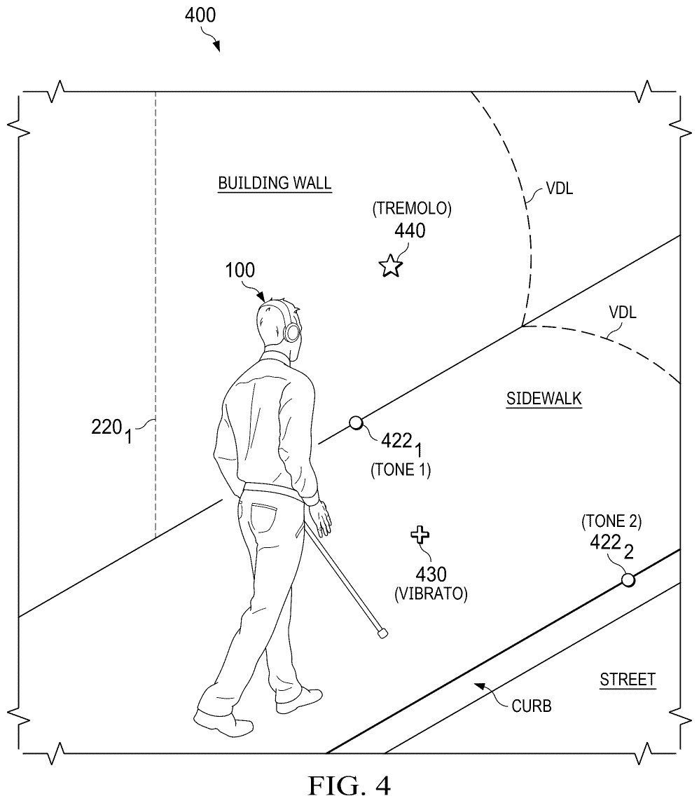

Next, FIG. 4 is a three-dimensional view of an example scenario 400 of a user wearing system 100 walking along a sidewalk with a building wall to the user's left and a street curb to the user's right. In this example, the object mapping system 104 may identify the sidewalk edges 4201, curb edge 4202, the sidewalk, and the building wall, and control circuitry 110 may determine center points 4221 and 4222 of the respective lengths of the sidewalk edge 4201 and curb edge 4202 within the viewed space VS, along with a center point 430 of the sidewalk area (horizontal plane) within the viewed space VS, and a center point 440 of the building wall (vertical plane) within the viewed space VS.

The control circuitry 110 may generate and output, via wearable stereo speaker system 106 of system 100, (a) a first tone indicating the location of the sidewalk edge center point 4221, (b) a second tone indicating the location of the curb center point 4222, (c) a tone with vibrato indicating the location of the center point 430 of the sidewalk within the viewed space VS, and (d) a tone with tremolo indicating the location of the center point 440 of the building wall within the viewed space VS.

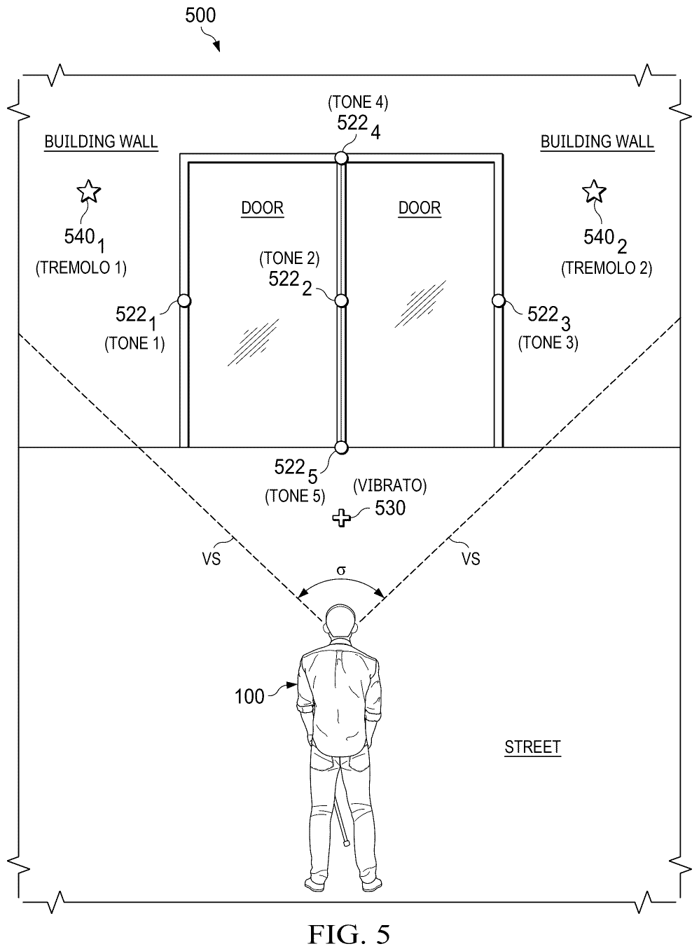

Next, FIG. 5 is a three-dimensional view, from behind the user, of an example scenario 500 of the walking along a street toward a building with double doors. In this example, the object mapping system 104 may identify door edge center points 522₁-522₅, along with a center point 530 of the street area (horizontal plane) within the viewed space VS, and center point 5401 and 5402 of the areas of the building wall (vertical plane) on either side of the double door.

The control circuitry 110 may generate and output, via wearable stereo speaker system 106 of system 100, (a) respective tones indicating the respective locations of the door edge center points 522₁-522₅, (b) a tone with vibrato indicating the location of the center point 530 of the street, and (c) a respective tone with tremolo indicating the respective location of the building wall area center points 5401 and 5402.

Although example embodiments have been described above, other variations and embodiments may be made from this disclosure without departing from the spirit and scope of these embodiments.

1. A system, comprising:
a view direction sensor configured to determine a viewing direction of the user;
an object mapping system to determine a location of an object feature of an object relative to a user;
a wearable stereo speaker system including a first speaker and a second speaker; and
control circuitry to:
analyze the determined location of the object feature relative to the determined viewing direction of the user; and
output non-verbal sounds via the first and second speakers of the wearable stereo speaker system to indicate the determined location of the object feature relative to the determined viewing direction of the user.

2. The system of claim 1, wherein the object mapping system comprises a Lidar sensor system, an optical scanning system, a sonar-based sensor system, or a database storing object location data for respective object features of respective objects in an environment.

3. The system of claim 1, wherein the wearable stereo speaker system comprises headphones, a headset, earbuds, or earphones.

4. The system of claim 1, wherein the object feature comprises an edge of the object, a center point of an edge of the object, a plane of the object, or a center point of a plane of the object.

5. The system of claim 1, wherein the control circuitry includes circuitry to:
determine a class of the object feature from multiple different classes of object features;
select, from multiple different types of sound effects, a sound effect corresponding with the determined class of the object feature; and
output the selected sound effect via the wearable stereo speaker system to indicate the class of the object feature.

6. The system of claim 5, wherein the different classes of object features include an object edge feature and an object plane.

7. The system of claim 5, wherein the different types of sound effects include at least one of a vibrato or a tremolo.

8. The system of claim 1, wherein the control circuitry includes circuitry to dynamically adjust an audio effect of respective non-verbal sounds output by the wearable stereo speaker system as a function of a distance of the detected object feature relative to the user, wherein the audio effect includes at least one of an amplitude, a pitch, a vibrato speed, or a tremolo speed.

9. The system of claim 1, wherein the control circuitry includes circuitry to dynamically adjust an audio effect of respective non-verbal sounds output by the wearable stereo speaker system as a function of a size of the detected object feature, wherein the audio effect includes at least one of an amplitude, a pitch, a vibrato speed, or a tremolo speed.

10. The system of claim 1, wherein:
the object mapping system is configured to determine a respective location of each of multiple object features in a field of view of the user; and
the control circuitry is configured to output respective non-verbal sounds for each of the multiple object features via the wearable stereo speaker system, wherein the respective non-verbal sounds indicate the respective location of each of the multiple object features relative to the user.

11. The system of claim 10, wherein the control circuitry is configured to output the respective non-verbal sounds for the multiple object features simultaneously via the wearable stereo speaker system.

12. The system of claim 10, wherein the control circuitry is configured to output the respective non-verbal sounds for the multiple object features in an alternating manner.

13. The system of claim 1, wherein the view direction sensor is securable to the user head and configured to determine the viewing direction of the user by determining an angular orientation of the user's head.

14. The system of claim 1, wherein the control circuitry includes circuitry to output differential audio signals from the first speaker and second speaker to create a stereo effect indicating to the user a lateral direction of the object feature relative to the viewing direction of the user.

15. The system of claim 1, wherein the control circuitry includes circuitry to dynamically adjust an audio effect of respective non-verbal sounds output by the wearable stereo speaker system as a function of the determined location of the object feature relative to the determined viewing direction of the user.

16. The system of claim 1, wherein the control circuitry includes circuitry to adjust an angular field of view as a function of the detected viewing direction of the user, wherein the angular field of view at least partially defines an viewed space in which a detection of the object feature causes the output of respective non-verbal sounds via the wearable stereo speaker system.

17. The system of claim 16, wherein:
the view direction sensor is configured to determine a vertical viewing angle of the user; and
the control circuitry includes circuitry to adjust an angular field of view in at least one direction, wherein the angular field of view at least partially defines a viewed space in which a detection of the object feature causes the output of respective non-verbal sounds via the wearable stereo speaker system.

18. A device, comprising:
a processor; and
non-transitory memory storing logic instructions executable by the processor to:
receive information from an object mapping system indicating a location of an object feature of an object relative to a user;
receive information from a wearable view direction sensor indicating a viewing direction of the user;
analyze the determined location of the object feature relative to the determined viewing direction of the user; and
output non-verbal sounds via a wearable stereo speaker system to indicate the determined location of the object feature relative to the determined viewing direction of the user.

19. The device of claim 18, wherein the logic instructions are executable by the processor to dynamically adjust an audio effect of respective non-verbal sounds output by the wearable stereo speaker system as a function of a distance or a size of the detected object feature relative to the user, wherein the audio effect includes at least one of an amplitude, a pitch, a vibrato speed, or a tremolo speed.

20. A method, comprising:
receiving, by a control circuit, information from an object mapping system indicating a location of an object feature of an object relative to a user;
receiving, by the control circuit, information from a wearable view direction sensor indicating a viewing direction of the user;
analyzing, by the control circuit, the determined location of the object feature relative to the determined viewing direction of the user; and
outputting, by the control circuit, non-verbal sounds via a wearable stereo speaker system to indicate the determined location of the object feature relative to the determined viewing direction of the user.
